(19) United States
(12) Patent Application Publication
(10) Pub. No.: US 2007/0120281 A1
(43) Pub. Date: May 31, 2007

(54) Manufacture of fine particles and nano particles and coating thereof

(76) Inventors: Boris Khusid, New Providence, NJ (US); Abhijit A. Gokhale, Harrison, NJ (US); Rajesh N. Dave, West Windsor, NJ (US); Robert Pfeffer, Scottsdale, AZ (US)

Correspondence Address: McCARTER & English, LLP;Financial Centre, Suite 304A, 695 East Main Street, Stamford, CT, 06901-2183, US

(21) Appl. No.: 11/594,411

(22) Filed: Nov. 8, 2006

Related U.S. Application Data
(60) Provisional application No. 60/734,573, filed on Nov. 8, 2005.

(51) Int. Cl. B29B 9/00

(52) U.S. Cl. 264/11

(57) ABSTRACT

An anti-solvent fluid technique is provided that assists in the formation, production and manufacture of fine particles including micro-sized and nanometer-sized particles for a wide variety of bio-medical and pharmaceutical applications. This technique is particularly effective for the manufacturing of polymers/biopolymers/drugs of micron, submicron or nano size as well as particle coating/encapsulation. Co-solvents are used to dissolve the polymer or mixture of polymers to make a solution. The method facilitates rapid drying of precipitated particles with reduced size and agglomerations. The method includes: (1) providing: an anti-solvent fluid; both organic solvents are soluble in the anti-solvent fluid; a second solvent that is at least partially soluble in or miscible with the first solvent; and a solute that is soluble in the first solvent and is substantially insoluble in the second solvent and the anti-solvent fluid; (2) capillary nozzle(s) are used to inject the solution into anti-solvent; (3) contacting the first solvent, the second solvent and the solute together to form a solution; (4) contacting the solution with the anti-solvent fluid to extract both solvents from the solution and precipitate the solute in the form of particles; and (5) contacting the solution with the anti-solvent fluids to extract both solvents from solution and precipitate the solute(s).

### CROSS REFERENCE TO RELATED APPLICATION(S)

The present application claims the benefit of a co-pending provisional patent application entitled “Method For Manufacturing Fine and Nano Particles and Coating Thereof,” which was filed on Nov. 8, 2005 and assigned Ser. No. 60/734,573. The entire contents of the foregoing provisional patent application are incorporated herein by reference.

### BACKGROUND

1. Technical Field

The present disclosure relates to systems and methods for production, formation, and/or manufacturing of micron, submicron and/or nano sized particles as well as particle coating utilizing anti-solvent fluids.

2. Background Art

Processing small particles is important for many fields of study and manufacture including but not limited to pharmaceutics, nutraceutics, food processing paint and copying technologies. Smaller particles sizes can lead to the development of new products as well as more effective products. New techniques for generating particles with decreased particle size, surface irregularities and agglomeration that also promote better film coating are necessary for future development in many scientific and industrial fields. Previous systems for particle coating have been described in commonly assigned U.S. patent application Ser. No. 10/820,091, entitled “Polymer Coating/Encapsulation of Nanoparticles Using A Supercritical Antisolvent Process,” the contents of which are incorporated in their entirety by reference herein.

Supercritical Anti-Solvent Fluid (SAS) techniques have been well established in industry. Exemplary techniques include taking a target substance and dissolving or suspending the substance in a solvent to create a solution. The solution is then exposed to a supercritical fluid to extract the solute by way of particle precipitation. The particle size of the precipitate is decreased and fewer agglomerates are generally present. Typical SAS techniques generally involve dissolving the solute in an organic solvent. However, existing techniques often generate agglomerates caused by particle contact during nucleation or plasticization of some materials. Agglomeration is often encountered during the precipitation step.

One particular SAS-type technique is known as Solution Enhanced Dispersion by Critical Fluids (SEDS), described in WO-95/01221 and modified in WO-96/00610. These references describe a technique wherein the solution is dispersed mechanically into separate fluid elements by the supercritical fluid and the solvents are simultaneously removed to effect particle precipitation. Accordingly, the dispersion and extraction of the solution or vehicle (solvent) occur substantially simultaneously by the action of the supercritical fluid step. The SEDS technique involves a method wherein the supercritical fluid is used both for its chemical properties and as a spray enhancer by mechanical effect: a nozzle with two coaxial passages allows introduction of a supercritical fluid and a solution of active substance(s) into the particle formation vessel where pressure and temperature are controlled.

A further exemplary technique is described in the U.S. Pat. No. 6,576,262 to Hanna, which requires the use of two supercritical fluids. Accordingly, a target solution is prepared containing a target substance dissolved in a vehicle which is either a near-critical fluid or a first supercritical fluid. The target solution is then introduced into a particle formation vessel, at which point the target solution in the particle formation vessel is contacted with a second supercritical fluid. This step typically takes place under conditions which allow the second supercritical fluid to cause particles of the target substance to precipitate from the target solution.

An additional exemplary technique is described in the US Publication 2004/020074 to Shekunov. The Shekunov publication describes a method that includes providing a supercritical fluid, a first solvent that is soluble in the supercritical fluid, a second solvent that is substantially insoluble in the supercritical fluid and is at least partially soluble in or miscible with the first solvent, and a solute that is soluble in the first solvent and is substantially insoluble in the second solvent. The first solvent, the second solvent and the solute are combined to form a solution. Contacting the solution with the supercritical fluid extracts the first solvent from the solution and precipitates the solute in the form of particles that are suspended in the second solvent.

Particle coating involves the application of a material onto the surface of individual particles to modify their surface properties, such as flowability, wettability, controlled release, flavor, taste, etc. (See, e.g., Yulu Wang, Dongguang Wei, Rajesh Dave, Robert Pfeffer, Martial Sauceau, Jean-Jacques Letourneau, Jacques Fages, “Extraction and precipitation particle coating using supercritical CO₂,” Powder Technology 127 (2002) pages 32-44.) It is difficult to coat individual submicron or nano sized particles with traditional techniques. (See, e.g., Y. Wang, Rajesh N. Dave, Robert Pfeffer, “Polymer coating/encapsulation of nanoparticles using a supercritical anti-solvent process,” J. of Supercritical Fluids 28 (2004) pages 85-99.) The coating or encapsulation of nanoparticles has been found to be of particular interest for the controlled release of drugs, genes, and other bioactive agents. Controlled release systems provide benefits including protection from rapid degradation, targeting delivery, control of the release rate, and prolonged duration of bioactive agents. (See, e.g., J. C. Leroux, E. Allémann, F. D. Jaeghere, E. Doelker, R. Gurny, “Biodegradable nanoparticles—from sustained release formulations to improved site specific drug delivery,” J. Control. Rel. 39 (1996) page 339.)

Supercritical fluids show promise in coating of nano and submicron sized particles. Boutin et al. investigated the co-precipitation of herbicide and biodegradable polymers by an supercritical anti-solvent technique. (See, e.g., O. Boutin, E. Badens, E. Carretier, G. Charbit, “Co-precipitation of a herbicide and biodegradable materials by the supercritical anti-solvent technique”, J. of Supercritical Fluids 31 (2004) pages 89-99.) The purpose of the investigation was to coat the herbicide particles with biodegradable polymers to achieve controlled release of a herbicide drug. Different coating substances were tested in order to study release kinetics. The positive effect of the embedded polymer upon herbicide release was evidenced by kinetic results. As the particle size was increased, its specific surface area was decreased and the kinetics of the release of the active molecule was found to be slowed down.

Ribeiro Dos Santos et al. investigated the coating of protein particles in order to achieve sustained-release. (See, I. Ribeiro Dos Santos, J. Richard, B. Pech, C. Thies, J. P. Benoit, “Microencapsulation of protein particles within lipids using a novel supercritical fluid process,” International Journal of Pharmaceutics 242 (2002) pages 69-78.) Lipids (Gelucire and Dynasan) were used as coating materials. Controlled release with a limited burst effect was achieved at 37° C. over a 24 hour period. With Gelucire, the initial burst was as small as 40% whereas with Dynasan, the initial burst was up to 70%. However, for coated protein, controlled release was obtained for both lipids.

A particular technique to coat fine particles was described by Schreiber et al. (See, Ralph Schreiber, Carsten Vogt, Joachim Werther, Gerd Brunner, “Fluidized bed coating at supercritical fluid conditions,” Journal of Supercritical Fluids 24 (2002) pages 137-151; and Ralph Schreiber, Britta Reinke, Carsten Vogt, Joachim Werther, Gerd Brunner, “High-pressure fluidized bed coating utilizing supercritical carbon dioxide,” Powder Technology 138 (2003) pages 31-38.) Host particles (silica or glass beads) were fluidized in a high pressure fluidized bed and then a homogeneous mixture of molten paraffin and super critical CO₂ was injected from the bottom of the fluidized bed. Due to different conditions in the mixing-autoclave and the fluidized bed, the paraffin precipitated in the vicinity of the nozzle and adhered to the solid particles. The coating experiments were carried out at fluid velocities up to 2.23 times the minimum fluidization velocity. The operating conditions for the coating process were determined by investigation of the system paraffin-CO₂ by means of solubility and differential scanning calorimetry measurements. An even distribution of the coating material within the fluidized bed was observed at fluid velocities higher than 1.2 times the minimum fluidization velocity.

This technique could be used for coating active ingredients for controlled release. Paraffin was uniformly distributed on the particles, but a complete coating could not be achieved with this method. Various particles with sizes between 100 and 200 μm were encapsulated with waxes commonly used in technical coating applications. A smaller pressure drop across the nozzle led to more uniform and even coatings. Glass beads, ceramic spheres, potassium chloride, and lactose showed similar coating results, whereas different morphologies were observed with a plastic material, characterized by a rougher surface and a lower surface energy. The high quality of the coating was confirmed by standard dissolution tests with coated potassium chloride crystals and lactose agglomerates. A high-pressure fluidized bed was successfully used to create thin, uniform and solvent-free paraffin coatings. The use of paraffin having a low glass transition temperature near the operation temperature of the fluidized bed led to a high agglomeration tendency, whereas hardly any agglomeration was observed using paraffin with a higher glass transition temperature. Ceramic beads, potassium chloride crystals and lactose agglomerates were successfully coated as well. Interfacial tensions and surface energies seemed to have an influence on the spreading of the coating material on the surface. In the case of plastic granules the spreading was impeded also due to its rougher surface in comparison to the other materials.

Krober et al. used a supercritical fluidized bed to coat fine and heat-sensitive particles. It was shown that the fluidization of particles under sub or supercritical conditions is different from that under atmospheric pressure. (See, H. Krober, U. Teipel, “Microencapsulation of particles using supercritical carbon dioxide,” Chemical Engineering and Processing 44 (2005) pages 215-219.) By increasing pressure, the minimum fluid velocity necessary to start fluidization decreases. It was possible to fluidize glass beads with a mean particle size of 7.4 μm. Stearyl alcohol was used for the coating experiments with glass particles of a mean particle size of 70 μm. Complete coatings with a layer thickness between 1 and 8 μm was achieved depending on the coating time and process conditions.

Wang et al. investigated the coating of nano and submicron sized silica particles using an SAS process. (See, e.g., Y. Wang, Rajesh N. Dave, Robert Pfeffer, “Polymer coating/encapsulation of nanoparticles using a supercritical anti-solvent process,” J. of Supercritical Fluids 28 (2004) pages 85-99; and Y. Wang, Robert Pfeffer, Rajesh Dave, Robert Enick, “Polymer Encapsulation of Fine Particles by a Supercritical Antisolvent Process,” AIChE Journal, 51 (2005) pages 440-455.) They suspended silica particles in the polymeric solution and then the suspension was sprayed into supercritical CO₂ using 254-μm sized capillary nozzle. Effects of various operating conditions, e.g., ratio of host particles to polymer, flow rate of solution injection, use of surfactant, temperature, and pressure, were investigated. Silica particles as small as 16 nm were successfully coated with this technique. The mechanism of the coating process was explained by Shen. (See, Y. Shen, Dissertation on supercritical antisolvent process for particle formation and polymer coating, New Jersey Institute of Technology, December 2005.) Shen used different biopolymers as coating materials. For different polymers, Shen found different types of coating with different coating thicknesses. Based on the experimental investigation, Shen proposed a model explaining the mechanism of particles coating using supercritical fluids.

Although numerous publications have contributed to the design of SAS apparatus and product development, SAS processes are still optimized empirically due to a limited base of data concerning the dynamics of phenomena underlying this process. Accordingly, current publications and technical teachings only utilize “good” polymer solvents or their mixtures and relatively wide nozzles, thereby limiting the utility and applicability of SAS techniques. These and other disadvantages and/or limitations are addressed and/or overcome by the methods of the present disclosure.

### SUMMARY OF THE INVENTION

Methods according to the present disclosure take distinguishing properties of anti-solvent fluids, including critical, supercritical, subcritical and near supercritical fluids, to exhibit significant solvent strength when they are compressed to liquid-like densities. By operating in and around the critical region, the pressure and temperature are used to regulate the fluid density, which, in turn, regulates the solvent power of an anti-solvent fluid. A wide range of materials can be processed and a variety of particulate morphologies can be formed through this process. Methods according to the present disclosure encompass the use of a mixture of both “good” and “poor” solvents injected through micro-nozzles. Since the interactions between segments of solute and molecules of solvent are thermodynamically favored in the good solvents, while the interactions between the segments of solute and molecules of the solvent are thermodynamically unfavorable in poor solvents, the interplay of the competing forces create an ideal environment for a solute to precipitate once it contacts the anti-solvent fluid.

According to a particular exemplary embodiment of the present disclosure, a solution of a compound of interest or target compound is sprayed through a nozzle into a chamber containing a highly compressed gas or anti-solvent fluid, which is miscible with the solvent, but is an anti-solvent for this particular compound. The dispersion of the liquid solution in such a medium generates a high degree of supersaturation, leading to the formation of fine, uniform particles. The anti-solvent fluids are compressed to liquid-like densities by adjusting the pressure and temperature to create a critical region and regulate the fluid density, thereby regulating the solvent power of an anti-solvent fluid. The recovery and separation of the anti-solvent from the solvent and solid products is then performed by a simple depressurization step to isolate the target particles.

In general, SAS processing benefits from fast mass transfer in supercritical fluids due to low viscosity and high diffusivity relative to liquids. Carbon dioxide is a suitable fluid and a common choice for SAS applications since it is non-flammable, non-toxic, inexpensive, and environmentally benign. Particular features of SAS and the present disclosure facilitates use/processing of a wide range of materials and formation of a variety of particulate morphologies.

In an exemplary embodiment, the presence of a particle or solute is required. The solute particle (target particle(s)) may be in a single or multi-component form. By way of example only the solute may be a protein, a polymer, a drug molecule, or any other substance from which one desires to obtain fine particles. Furthermore, by way of example only, and without limitation, the solute and the resulting target particles may also be in a multi-component solute such as a mixture, a substrate particulate material or a matrix. When there are particulates which are insoluble in the solvents along with a solute (such as a polymer or lipid), this process can lead to film coating of the precipitated solute over the insoluble particles. The disclosed system can involve the presence of more than one solute, hence the final precipitated product may be a combination of these solutes in a particulate form. Additionally, such solutes may exist as a result of interactions with the solvents. The target particles may also result from an in situ reaction. Exemplary applications of the methods associated with the present disclosure include but are not limited to: polyvinylpyrrolidone (PVP), polylactic acid (PLA), polylactic co-glycolide (PLGA), Eudragit, and polymethylmethacrylate (PMMA). These materials may also be used in conjunction with insoluble substrate particles to form encapsulated particles.

An exemplary embodiment of a method according to the present disclosure includes precipitation of the solute(s) in a mixture of “good” and “poor” solvents injected through micro-nozzles into a precipitation vessel or pressure chamber. Solvents include any medium in which another substance may be dissolved. In polymers, and analogously in other solvents, the conformation of individual polymer chains depends on the solvent properties. In good solvents, the monomers effectively repel each other, preferring to be surrounded by solvent molecules. This effect leads to a swollen coil conformation for flexible polymers in good solvent. Thus, the intra-chain repulsion between the segments works to expand the polymer dimensions, as does the solvent-solute interaction. In less favorable solvents, the solvent-solute and solute-solute interactions have opposite signs. In poor solvent, conversely, the monomers try to exclude the solvent molecules and effectively attract one another, and a flexible chain forms a compact globule of roughly spherical shape to minimize the contacts between monomers and solvent. Thus, in poor solvents, these attractive and repulsive forces are no longer balanced, and the polymer chain collapses. There can be any number of solutes and solvents so long as the core requirements of the method described herein are met. There is no requirement that either solvent is organic or polar, so long as the combination complies with the core requirements as stated above.

For the purpose of an exemplary application, additives can be included without altering the versatility and/or effectiveness of the presently described methods. Some examples of additives include, by way of example only, surfactants or surface active compounds, which can be used in the first or the second solvent in order to promote agglomeration and/or particle growth kinetics.

For the purposes of the present disclosure, the term “miscible” describes when two fluids are miscible in all proportions under the operating conditions used, and “substantially miscible” encompasses the situation where the two fluids can mix sufficiently well, under those operating conditions, as to achieve the same or a similar effect, i.e., dissolution of the fluids in one another and precipitation of the target substance.

For the purposes of present disclosure, the term “anti-solvent” is typically a solvent that extracts a target substance in a decreased particle size from a solution created by dissolving or suspending a solute in a solvent or solvents. The anti-solvent can be a supercritical fluid, a subcritical fluid, a critical fluid or a near critical fluid. “Supercritical fluid” means a fluid at or simultaneously above its critical pressure (P_{c}) and critical temperature (T_{c}). For purposes of this application, temperatures just above the critical temperature are generally preferred, but are not necessarily required, depending on the pressure of the system. In an exemplary embodiment, limitations to pressure and temperature include: (1) ensuring that the temperature of the supercritical fluid is below the melting point(s) of the solute(s); (2) ensuring that the temperature is below the glass transition temperature(s) of the solute(s); and (3) ensuring there are no adverse effects on the composition of the materials used. However, some fluids have particularly low critical pressures and temperatures, and may need to be used under operating conditions well in excess of those critical values. Typically, any anti-solvent fluid can be used so long as the first and second solvents are soluble in the anti-solvent fluid and that the solute is insoluble in the anti-solvent fluid. Exemplary anti-solvent fluids include but are not limited to: carbon dioxide (CO₂) and nitrogen gas (N₂). The anti-solvent fluid may enter the pressure chamber by any means adapted to achieve the desired result described herein.

For purposes of the present disclosure, the term “near-critical fluid” generally encompasses both high pressure liquids and dense vapors under the proper circumstances. High pressure liquids should typically be at or above their critical pressure but below their critical temperature. In a particular embodiment, the high pressure liquids should generally be only minimally below their critical temperature. Dense vapors are fluids which are at or above their critical temperature but below their critical pressure. Again, optimization generally occurs when the dense vapors are only minimally above their critical temperature.

In an exemplary method according to the present disclosure, the solution or suspension is composed of two or more component fluids or solvents and one or more solutes. Typically both solvents are soluble in the anti-solvent fluid and the second solvent is at least partially soluble in or miscible with the first solvent. Two solvents are typically chosen based on how soluable they are with the solute which is the desired end product. In good solvents, the interactions between segments of solute and molecules of solvent are thermodynamically favored; hence the solute expands in good solvents. In poor solvents, the interactions between the segments of solute and molecules of the solvent are thermodynamically unfavorable thus the solute contacts in the poor solvent and precipitates out of the solution. The first solvent should be a good solvent or at least a more favorable solvent in the context of the solute. The second solvent should be a poor solvent in the context of the solute. Additional solvents can be used so long as there is some good solvent and some poor solvent in the system. To this end, solute must be soluble in the first solvent and is substantially insoluble in the second solvent and the anti-solvent fluid.

For the purposes of the present disclosure, the pressure chamber can typically be a vessel in which extraction of the particulate matter is precipitated into particle form. In an exemplary embodiment, the pressure in the chamber can be achieved through a high pressure gas cylinder or a high pressure pump, for example from a High Performance Liquid Chromatography (HPLC) instrument. In an exemplary embodiment, a solution pump, although optional, can be an effective way to facilitate the effectiveness and speed of the presently disclosed method.

In an exemplary embodiment, a capillary nozzle defines an aperture which permits the solution to enter the pressure chamber. There are no size restrictions on the size of the capillary nozzle, however, in an exemplary embodiment of the present disclosure, the capillary nozzle is larger than 0.510 μm.

In an exemplary embodiment, the capillary nozzle(s) is used to inject the solution into anti-solvent (CO₂). The capillary nozzle can generally be of any size; however, an inner diameter of 2 μm or larger is generally found to deliver effective results. The solution is dispersed into the anti-solvent fluid through the capillary nozzle. This results in contacting the solution with the anti-solvent fluid. The aim of this step is to extract both solvents from the solution and precipitate the solute in the form of particles referred to as the target particles.

The terms “disperse” and “dispersion” refer generally to the transfer of kinetic energy from one fluid to another. Dispersion in an anti-solvent environment generally results in the formation of droplets of the fluid or solvents. The kinetic energy resulting from the dispersion is transferred.

According to the present disclosure, the term “target particles” may be any substance which needs to be obtained in a particulate form without limitation. For example, the target particles may be organic or inorganic, monomeric or polymeric. Exemplary substances can include but are not limited to pharmaceutical or neutraceutical materials. Other embodiments, for example, include creating target particles useful in or for: food products, food byproducts, the food industry, ceramics, explosives, photographic industries, dyes, coatings, etc. Additionally, the target particles may be particles that are coated by a film of polymer or similar substance.

Exemplary methods according to the present disclosure can be used for any solute(s), target particle(s), solvent(s), anti-solvent fluid(s), temperature, pressure, etc., so long as the operating conditions are adjusted so that the minimum requirements of interactions as described herein are met. The ability to adjust this method illustrates its overall versatility.

### BRIEF DESCRIPTION OF THE DRAWINGS

To assist those of ordinary skill in the relevant art in making and using the subject matter hereof, reference is made to the appended drawings, wherein:

FIG. 1 is a block diagram illustrating the steps of an exemplary method associated with the present disclosure;

FIG. 2 is a schematic diagram of an exemplary setup for an experiment according to a method associated with the present disclosure;

FIG. 3 depicts the morphology of particles precipitated from 2 wt %-PVP solution in (a) DCM, (b) DCM-20, (c) DCM-40 wt % acetone mixture, temperature 35° C., flow rate 0.2 ml/min, chamber pressure 79 bar, nozzle ID 40;

FIG. 4 depicts PVP particles precipitated from 2 wt %-PVP solution in DCM-40 wt % acetone mixture, nozzle ID 20 μm, flow rate 0.2 ml/min, temperature 35° C., chamber pressure (a) 82 bar and (b) 100 bar; the average particle size was (a) 80 nm and (b) 120 nm;

FIG. 5 depicts DCM jets injected through (a) 40-μm and (b) 20-μm nozzles at Reynolds number 740, pressure 80 bar, temperature 35° C., SEM photos of PVP particles precipitated from DCM-40 wt % acetone mixture at 82 bar and 35° C. injected through (a) 40-μm and (b) 20-μm nozzles at different flow rates but at Reynolds Number 740;

FIG. 6 illustrates an exemplary ultrasonic nozzle used for coating experiments;

FIG. 7 shows SEM images of 180 nm sized silica particles coated with PMMA under the following operating conditions: pressure=80 bar, solution flow rate=4 mL/min, temperature=35° C., Silica 180 nm coated with: (a) PMMA 9.1 wt/wt%, (b) 16.7 wt/wt %, and (c) 23 wt/wt %;

FIG. 8 represents particle size distribution for PMMA coated silica particles under the following operating conditions: 80 bar, 4 mL/min, 35° C.; host particle size is: (a) 180 nm, and (b) 2 μm;

FIG. 9 shows the particle size distribution of PMMA coated silica particles (180 nm) under the following operating conditions used for coating experiments: 80 bar, 4 Watts, 35° C., 4 mL/min; the PMMA to silica ratio was: (a) 9.1 wt/wt %, (b) 16.7 wt/wt % and (c) 23 wt/wt %;

FIG. 9 (d) shows the silica particles suspended in DCM, acetone and in a mixture of DCM and acetone;

FIG. 10 shows SEM images of the silica 180 nm sized particles coated with PMMA: (a) DCM only; (b) Hexane 30 vol/vol % in DCM; (c) acetone only; (d) Hexane 30 vol/vol % in acetone and (e) Water 30 vol/vol % in acetone;

FIG. 11 shows the particles size distribution for silica 180 nm particles coated with PMMA, solvents used: acetone, DCM, acetone-hexane, DCM-hexane and acetone-water;

FIG. 12 shows the particle size distribution of PMMA coated silica particles with and without use of poor solvent: (a) PMMA is 9.1 wt/wt % with silica, (b) PMMA is 16.7 wt/wt % with silica and (c) PMMA is 23 wt/wt % with silica;

FIG. 13 shows the degree of agglomeration at an operating pressure, ultrasonic nozzle power, temperature and solution flow rate of 80 bar, 4 watts, 4 mL/min and 35° C., respectively.

FIG. 14 illustrates an experimental setup for the visualization of the liquid breakup injected into supercritical CO₂.

FIG. 15 illustrates images of the effects of solvent composition on particle morphology; SEM photos of synthesized PVP nanoparticles: Nozzle ID 40 μm, pressure 79 bar, temperature 35° C., solution injection rate 0.2 ml/min, DCM/acetone (v/v) solvents: (A) 100/0; (B) 80/20; (C) 60/40; and (D) jet breakup of DCM into supercritical CO₂;

FIG. 16 illustrates silica particles coated with EUDRAGIT; TEM-EELS images of EUDRAGIT encapsulated particles: (A) Zero loss, (B) Si-distribution, (C) superimposition of A and B, (D) original silica particles, (E) SEM image of particles coated with EUDRAGIT, the operating conditions were 80 bar, 35° C., and the solution flow rate was 4 ml/min, the ratio of host particles to guest particles was 9:1 wt/wt % for the coating experiment.

### DETAILED DESCRIPTION OF THE INVENTION

The present disclosure relates to particles of any size and in particular production, formation, and/or manufacture of micron, submicron or nano sized particles. The present disclosure further relates to particle coating. More particularly, the present disclosure relates to methods of formation and manufacture of nanoparticles utilizing anti-solvent fluids. An exemplary application of the present disclosure is effective in generating nanoparticles out of larger particles while reducing agglomerations. A further exemplary application is effective in coating fine particles with improved film-coating capability at reduced agglomeration of coated particles. An exemplary method according to the present disclosure facilitates rapid drying of precipitated particles with reduced size and agglomerations. This method may be applicable to a wide range of industries including pharmaceutics, nutraceutics, food processing, paint, ceramics, photography, explosives, dyes etc. An exemplary method utilizes mixtures of solvents, typically two solvents: one being a good solvent and the other being a poor solvent. Using both solvents facilitates extraction and precipitation without causing agglomerates or the need to mill the products, which typically results in a reduction of product yield.

In an exemplary method according to the present disclosure, poor solvent is used to dry resultant particles quickly and effectively leading to less agglomerations, smaller particle size and smoother particle surface. The use of poor solvent(s) also helps in improving supersaturation at lower solute concentrations, hence it leads to production of finer particles.

In an exemplary method, a solute is combined with a mixture of two or more previously mixed good or poor solvents. The resulting solution is placed in contact with a anti-solvent fluid thereby creating a mechanistically vastly different and superior precipitation technique. Typically, in a method associated with the present disclosure both solvents are soluble in the anti-solvent fluid. This creates a vast difference in the mechanism of the particulation and is generally a superior precipitation technique over the prior techniques. Moreover, exemplary methods according to the present disclosure need only utilize an anti-solvent solution and not necessarily a super-critical fluid.

An exemplary method according to the present disclosure is focused on the solubility of a solute in two solvent system. Typically, both “good” and “poor” solvents are mixed together to create a solution with a solute which is then injected through micro-nozzles. In good solvents, the interactions between segments of solute and molecules of the good solvent are thermodynamically favored; hence the solute expands in good solvents. In poor solvents, the interactions between segments of solute and molecules of the poor solvent are thermodynamically unfavorable thus the solute contracts in the poor solvent and precipitates out of the solution. Thus, the solute is soluble in good solvent(s) and substantially insoluble in poor solvent(s). Generally, the interactions between the good solvent(s), the poor solvent(s), and the solute cause the solute to precipitate out of the solution and away from both solvents simultaneously. The simultaneous events occur because each solvent is miscible in the other and the solute precipitates from both solvents. Since the overall solubility of the solute is significantly lower in the mixture of solvents than in the good solvent alone, it becomes easier to attain superstauration at lower solute concentrations resulting in more effective drying of target particles and prevention of agglomerate formation. Moreover, in an exemplary method, the solvent(s) can be recycled thereby saving money and reducing waste which is less harmful to the environment.

An exemplary method associated with the present disclosure is capable of smoothing surface irregularities of particles and producing and/or manufacturing targeted particles having micron, submicron or nano size, without agglomerations or additional milling, by facilitating fast drying of precipitated particles. Typical methods require both good and poor solvents to effectively optimize quantitative dynamics of the anti-solvent process.

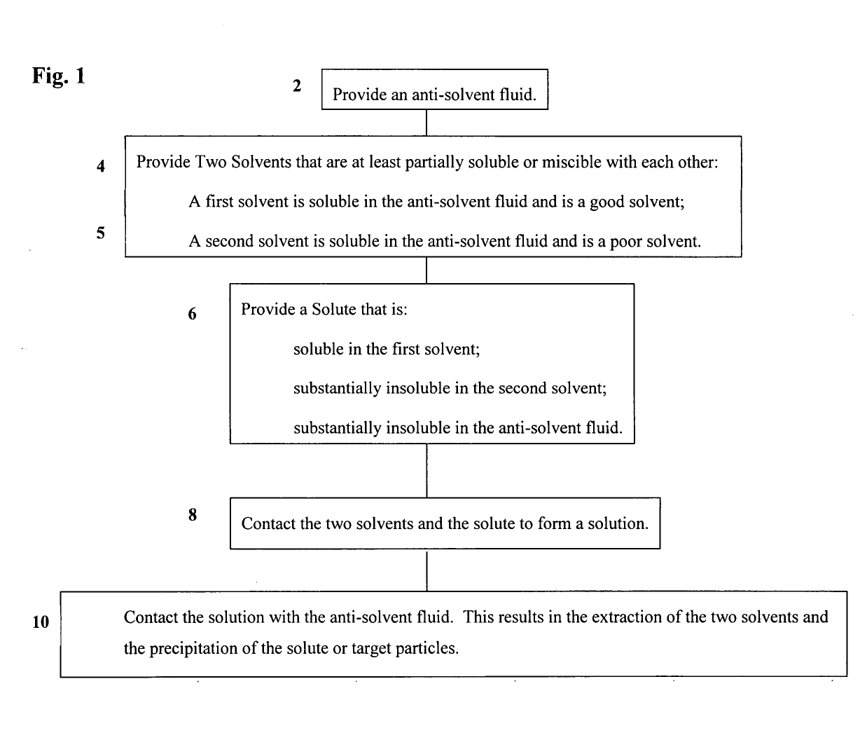

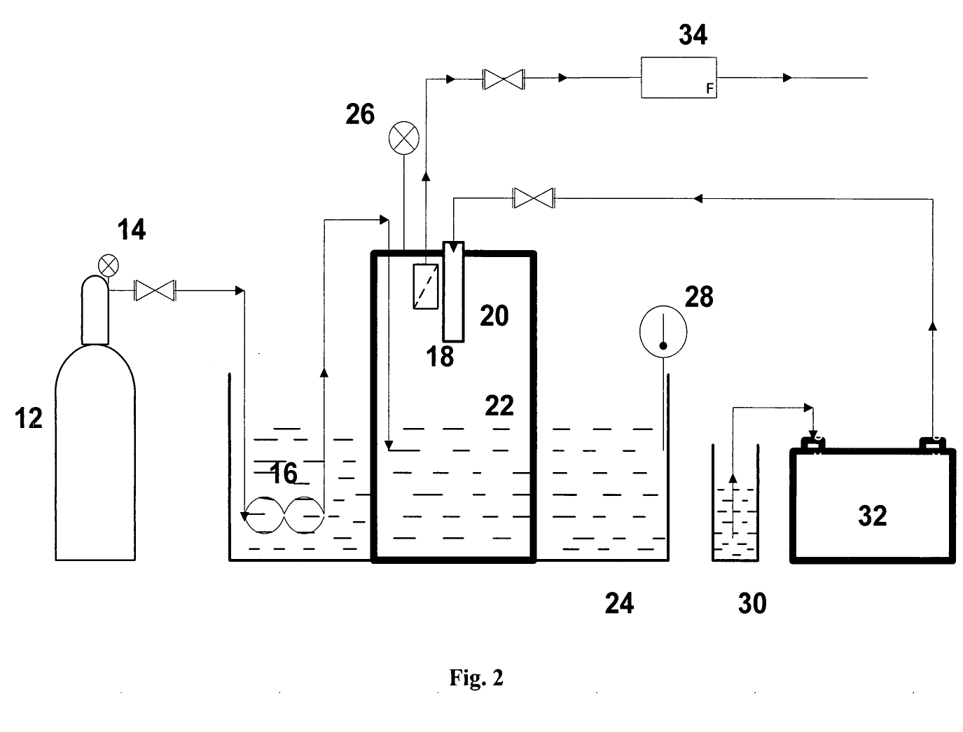

FIG. 1 illustrates the steps of an exemplary method associated with the present disclosure. FIG. 2 is a schematic diagram of the exemplary method described in FIG. 1. According to FIGS. 1 and 2, an anti-solvent fluid 2 is provided. A gas used to make the anti-solvent fluid 2 is stored in a gas container 12 (shown in FIG. 2) which is attached to a pressure regulator 14. Typically, gas container 12 is a gas cylinder. The gas, stored in container 12, is then pumped through a water bath 24. A coil 16 is positioned within bath 24 to heat the gas, which may be monitored by a thermometer 28. The heated gas is directed into a pressure chamber 22 having a pressure gauge 26. The pressurization and heating of the gas generates an anti-solvent fluid as shown in FIG. 1.

Referring to FIG. 1 again, a first solvent 4 and a second solvent 5, at least partially soluble or miscible with each other, are provided. Solvent 4 is soluble in anti-solvent fluid 2 and is characterized as a good solvent. Solvent 5 is soluble in anti-solvent fluid 2 and is characterized as a poor solvent. Solvent 4 and solvent 5 are combined in a solution tank 30 (shown in FIG. 2). A solute 6 (described in FIG. 1) having at least components of target particles, are provided. Solute 6 is soluble in solvent 4, substantially insoluble in solvent 5 and substantially insoluble in anti-solvent fluid 2. Solute 6 is added to solution tank 30 having the at least partially soluble or miscible solvent 4 and solvent 5, thereby creating a solution 8. Since solute 6 is soluble in solvent 4 (a good solvent), the intra-chain repulsion between the segments works to expand the solute's dimensions. Since, solute 6 is substantially insoluble in solvent 5, (a poor solvent), the attractive and repulsive forces are no longer balanced, and the solute contracts. In combination, the strengths of good solvent 4 and poor solvent 5 alter the solvent strength of the individual solvents and once solution 8 is injected into anti-solvent fluid 2, the poor as well as the good solvent dissolve into anti-solvent fluid 2 thereby precipitating the particles.

Generally, if only good solvent is used, some part of the solvent stays on the surface of a newly formed particle for a short time as the interactions between solvent molecules and solute (in one embodiment, the polymer chain) is thermodynamically favored, thereby eroding the surface and also re-dissolving the target particle surface which results in increased agglomeration. However, by combining good solvents and poor solvents, the poor solvent prevents extended exposure of good solvent to the newly formed particles and hence prevents agglomeration as well as surface irregularities. Additionally, if only the good solvent is used while the concentration of solute may be low, it can lead to no precipitation at all due to poor supersaturation.

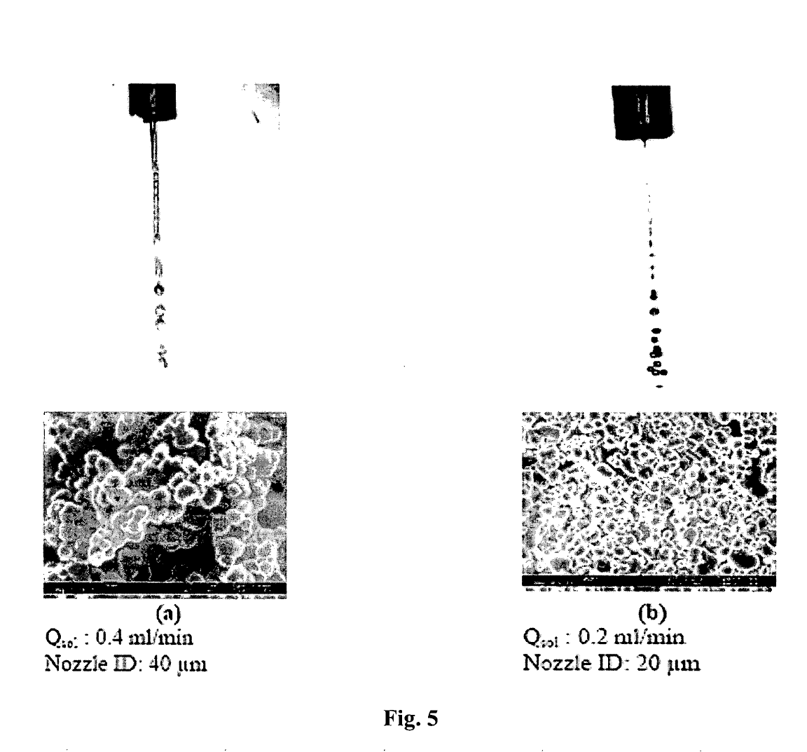

As described in box 10 of FIG. 1, solution 8 may be directed to pressure chamber 22 directly or through a solution pump 32 (shown in FIG. 2), typically used to enhance performance. The solution is then directed or forced through a capillary nozzle 20 and into pressure chamber 22. Solution 8 enters pressure chamber 22 through capillary nozzle 20 and thereby comes into contact with anti-solvent fluid 2. After particles are formed pressure chamber 22 must be depressurized in order to collect particles. Solution 8 can be emitted from capillary nozzle 20 in any form including for example, a jet or droplets shown in FIG. 5. First solvent 4 and second solvent 5 of solution 8, which are both soluble in anti-solvent fluid 2 dissolve and dissipate into the environment of pressure chamber 22. Due to competing forces of first solvent 4—solute and second solvent 5—solute interactions, as well as the interactions of the solvents with anti-solvent fluid 2, the solute will precipitate out of solution 8 and collect on the walls of pressure chamber 22. The precipitated solute is also known as the target particles. Anti-solvent fluid 2 circulates in pressure chamber 22 drying the target particles and preventing the solvents from remaining on the newly formed target particles. Thus the new target particles can dry more rapidly thereby decreasing agglomerations. Moreover, anti-solvent fluid 2 will carry away both first solvent 4 and second solvent 5 so that the target particles will dry again decreasing agglomerations.

The pressure in pressure chamber 22 is measured by pressure gauge 26. First solvent 4, second solvent 5 and anti-solvent fluid 2 are filtered out of pressure chamber 22 through a frit 18. The removal of first solvent 4, second solvent 5 and anti-solvent fluid 2 is optionally measured by a flow meter 34 and can be collected and reused. Once first solvent 4, second solvent 5 and anti-solvent fluid 2 are removed, pressure chamber 22 can be depressurized and then opened, such that the target particles can be collected.

In an exemplary embodiment of the present disclosure, an organic liquid solution of a compound of interest (e.g., a polymer in a liquid solvent composed of both a good solvent, such as Dichloromethane (DCM) and a poor solvent, such as acetone) is sprayed through a nozzle into a chamber containing a highly compressed gas or anti-solvent fluid (e.g., carbon dioxide), which is miscible with the solvent, but is an anti-solvent for this compound. Dispersion of the liquid solution in supercritical carbon dioxide generates a high degree of supersaturation, leading to the formation of fine, uniform particles. Recovery and separation of the anti-solvent from the solvent and solid products is then performed by a simple depressurization step.

In an exemplary embodiment of the present disclosure, a solute may further include, for example, a polymer type substance and/or a particulate material that does not dissolve in either solvent for the purpose of coating the particulate material with the soluble material upon contact with the anti-solvent. Thus, the slurry of solvents and solute along with the insoluble particulate materials is injected into the pressure chamber.

The following experimental examples illustrate further exemplary embodiments of the methods associated with the present disclosure:

### EXAMPLE 1

Experiments are conducted on solutions of high-molecular weight polyvinylpyrrolidone (PVP), Mw=1,300,000, in a binary mixture of good solvent, dichloromethane (DCM) (HPLC Grade, 99.7+%), and poor solvent, acetone (HPLC Grade, 99.5+%), in a high pressure carbon dioxide (CO₂) cylinder (Bone Dry, 99.9% pure). The PVP solubility in a binary mixture of DCM and acetone at normal pressure is measured using a laser scattering on a Coulter N4 Plus, for example.

Experimental setup is illustrated in FIG. 2. An exemplary high-pressure chamber 22 has double-sided (front and back) sapphire windows (320 mm×16 mm) for flow visualization. An exemplary visualization system (not shown) includes a microscope lens, a high-speed CCD camera, a computer with image capture software, and a Nd:YAG dual cavity pulsed laser that produces double shots with an exposure time from 5 μs to 15 μs delay. Polymer solution is injected into a compressed chamber 22 through a micro-nozzle 20 following a 15-min injection of CO₂. A back pressure regulator is used to control the flow rate of CO₂. Operational temperature is substantially maintained at 35° C. while the operational pressure varies from about 70 bar to about 120 bar. Experiments were conducted using 20 μm, 40 μm, and 127 μm nozzles. The flow regimes vary from dripping to spraying. Once the solution is injected, the solution pump is turned off whereas the CO₂ flow into the chamber continues for 2 hours to ensure the dryness of the precipitated particles inside the chamber. The CO₂ flow is subsequently stopped and the chamber is slowly depressurized. Polymer particles formed in the chamber are collected in air tight bottles for characterization. Characterization of PVP particles may be, for example, achieved using scanning electron microscopy (Leo 1530VP), laser scattering (Coulter N4 Plus), and sigma scan pro software for the quantification of SEM images.

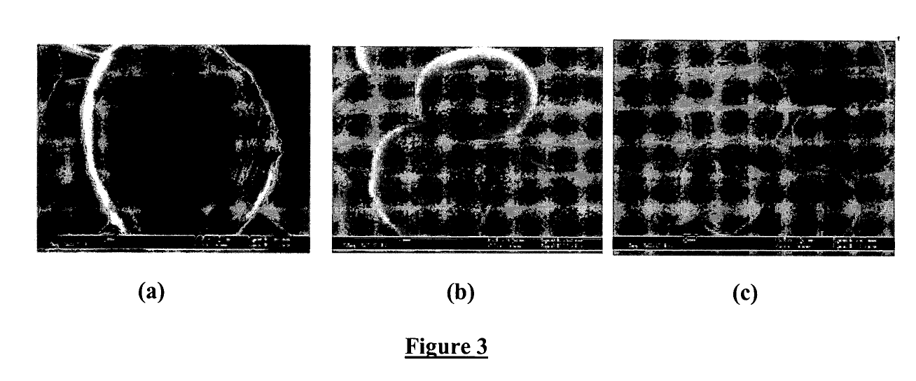

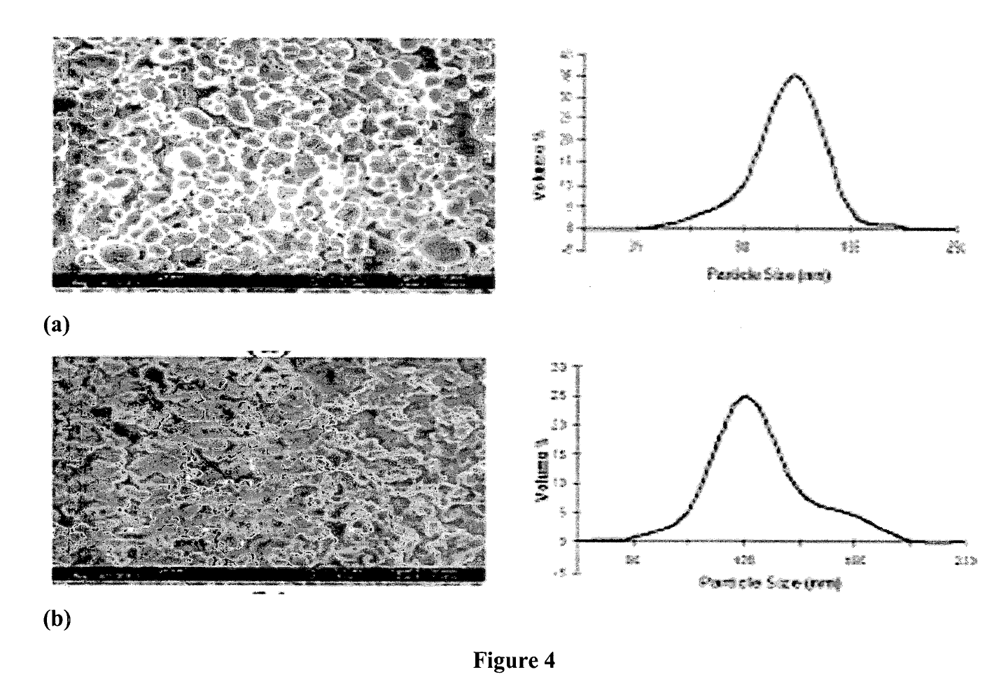

SEM photos shown in FIG. 3 and FIG. 4 illustrate the morphology of PVP particles formed using DCM and DCM-acetone solutions. Increasing the acetone content in the mixture is found to suppress the particle aggregation, eliminate their surface irregularities, and decrease the average particle size as shown in FIG. 3. With increasing operational pressure, particle size increases and particle size distribution broadens as shown in FIG. 4.

Particle size is found to decrease with decreasing nozzle diameter and increasing jet velocity. By varying solution flow rate, particles were synthesized using solutions injected through 40-μm and 20-μm nozzles at different velocities but at the same Reynolds number. FIG. 5 illustrates Rayleigh type breakup of two such jets. However, the size of particles formed in such jets occurs to be different, 280 nm diameter for 40-μm (shown in FIG. 5(a)) and 98 mn diameter for 20-μm nozzles (shown in FIG. 5(b)), respectively.

The use of a mixture of good and poor polymer solvents provides for an efficient method of smoothing surface irregularities of polymer particles, decreasing particle size, and reducing the time for drying particles from 2 hours to 30 minutes. By changing nozzle diameter, jet velocity, and CO₂ pressure, the size of PVP particles can be varied from micrometers to less than 100 nanometers. Operation at pressures slightly above the critical point favors the formation of a narrow particle size distribution. The characterization of PVP particles can be accomplished using scanning electron microscopy (Leo 1530VP), laser scattering (Coulter N4 Plus), and sigma scan pro software for the quantification of SEM images.

### EXAMPLE 2

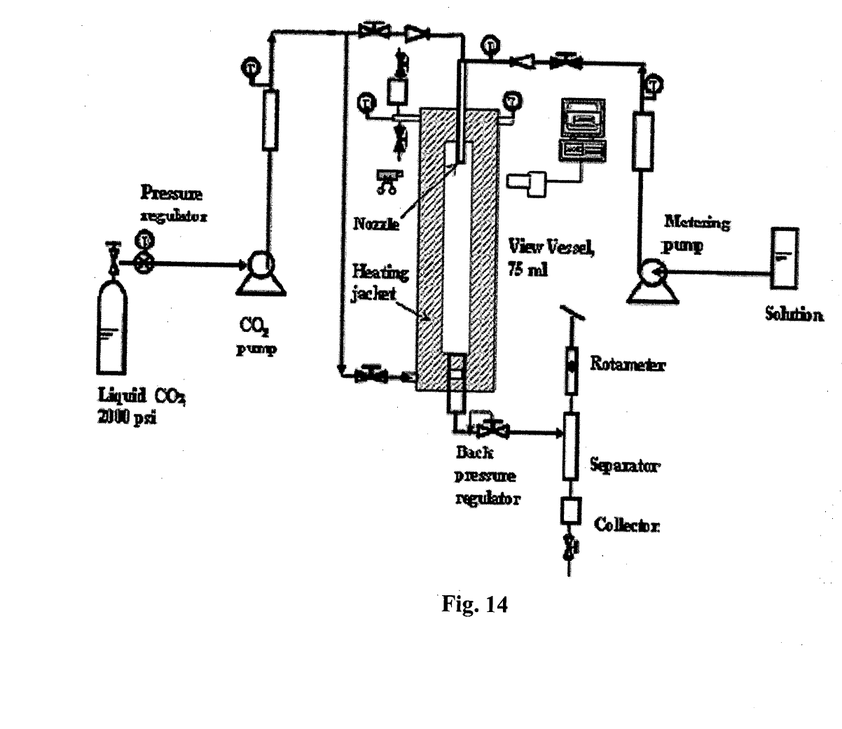

The SAS coating process is similar to the SAS particle formation process and can be performed near critical pressure and temperature. Polymethylmethacrylate (PMMA) polymer is dissolved in an organic solvent or combination of solvents and host particles (silica particles) are suspended in the solution. This solution is then sprayed into supercritical CO₂. An experimental setup used for coating work is similar to the setup illustrated in FIG. 14. A capillary tube is replaced by a coaxial ultrasonic nozzle to spray the suspension solution. The suspension solution is fed into a high pressure chamber through the central capillary of the ultrasonic nozzle and CO₂ is fed through the outer capillary. CO₂ flows continuously before start of the suspension injection and continues to flow 2 hours after the injection is stopped.

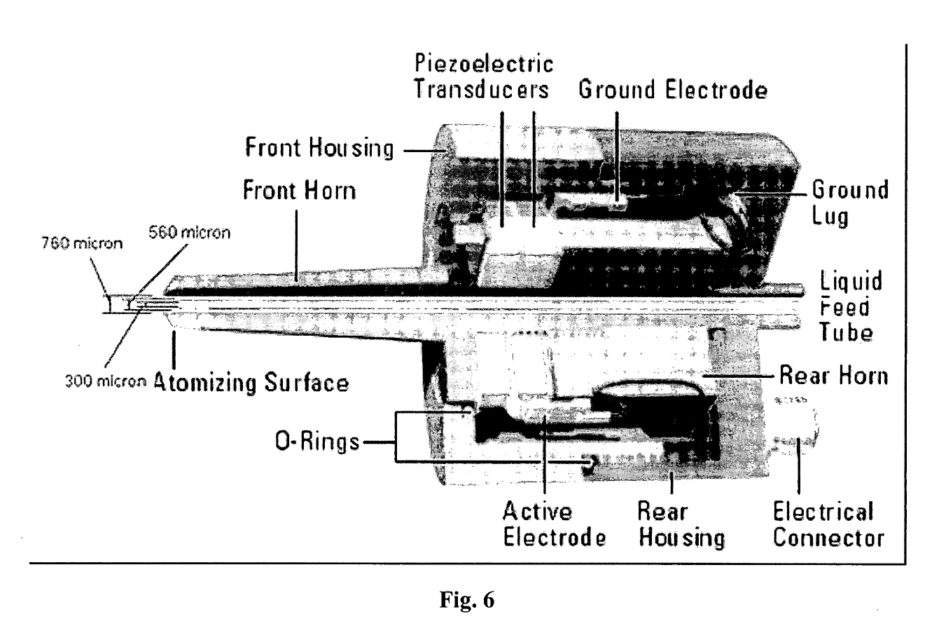

An exemplary ultrasonic nozzle is shown in FIG. 6. It comprises two coaxial nozzles. The smaller inner nozzle has an inner diameter of 300 μm with the wall thickness of 130 μm. The remaining part of the bigger nozzle defines a ring-shaped geometry with an inner diameter of 560 μm and outer diameter of 760 μm. A small mixing zone with the length of 1.02 mm is defined between the tips of the two nozzles. The ultrasonic nozzle is designed to work at a fixed frequency of 60 kHz. The inner nozzle is used to inject a polymer solution, whereas the outer nozzle is used to inject CO₂.

Referring to FIG. 14, high pressure CO₂ cylinders (Bone Dry, 99.9% pure) from MG Industries were used. Acetone (HPLC Grade, 99.5+%), DCM (HPLC Grade, 99.7+%) and PMMA from Sigma Aldrich were used. The critical point of pure CO₂ is approximately 31.1° C. and 73.8 bar. At the operating temperature of about 35° C., the critical pressures of the CO₂-DCM and CO₂-acetone mixtures are about 78 bar and 72 bar, respectively. (See, e.g., C.-Y. Day, C. J. Chang, and C.-Y. Chen, “Phase Equilibrium of Ethanol+CO₂ and Acetone+CO₂ at Elevated Pressures,” J. Chem. Eng. Data, 41 (1996) pages 839-843; (Addition/Correction); 44 (1999) pages 365-365; I. Tsivintzelis, D. Missopolinou, K. Kalogiannis, and C. Panayiotou, “Phase compositions and saturated densities for the binary systems of carbon dioxide with ethanol and dichloromethane,” Fluid Phase Equilibria 224 (2004) pages 89-96; and M. Stievano and N. Elvassore, “High-pressure density and vapor-liquid equilibrium for the binary systems carbon dioxide-ethanol, carbon dioxide-acetone and carbon dioxide-dichloromethane,” J. of Supercritical Fluids 33 (2005) pages 7-14.)

Silica particles (180 nm and 2 μm) were used as host materials. PMMA polymer was used as a coating material. Silica 2-wt/vol % to solvents was used in all of the coating experiments. The ratio of PMMA to silica was varied from 9.1 to 23 wt/wt %.

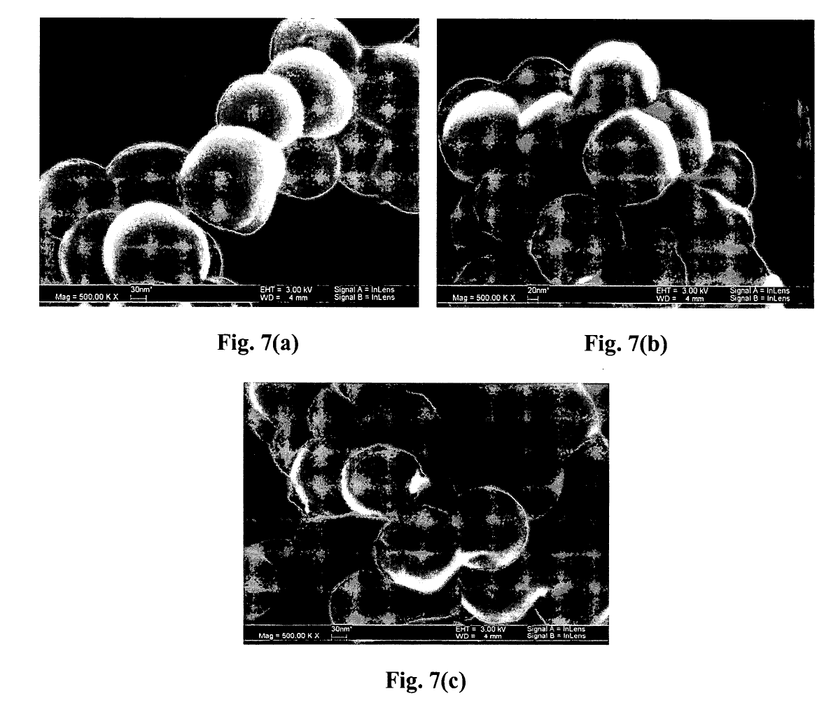

Silica particles 2 μm and 180 μm were used to coat with the PMMA polymer. The host particles to polymers ratio was varied from 9.1 to 23 wt/wt %. The higher the polymer ratio, the higher the aggregation was found in the coated silica particles. FIG. 7 shows the SEM images of the 180 nm sized silica particles coated with PMMA. Acetone was used to dissolve the polymer. The operating conditions were: pressure=80 bar; solution flow rate=4 mL/min; and temperature=35° C. FIG. 7 illustrates Silica 180 nm coated with PMMA: 9.1 wt/wt % in (a); 16.7 wt/wt % in (b); and 23 wt/wt % in (c).

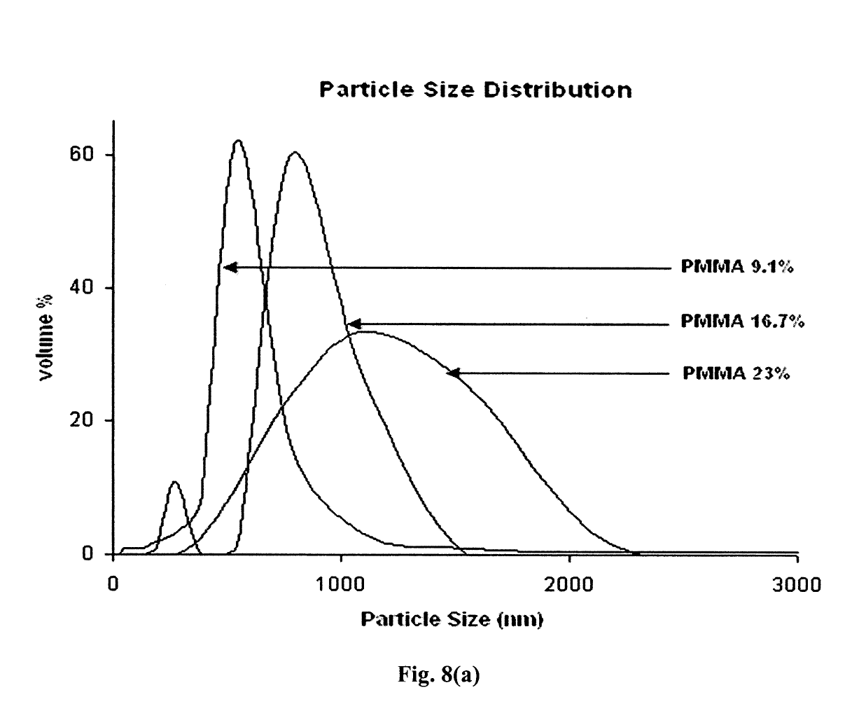

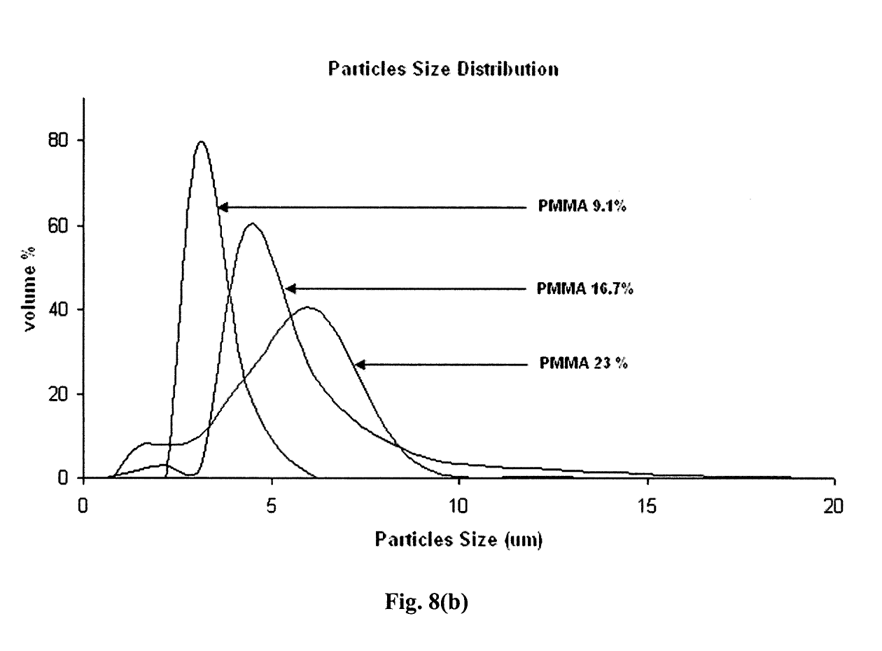

The particle size distribution for the PMMA coated silica particles is presented in FIG. 8. The operating conditions were 80 bar, 4 mL/min, 35° C. The host particle size is 180 nm in (a) and 2 μm in (b).

Choice of solvent is very crucial for coating experiments. Better dispersion of silica particles in the solvent helps to reduce aggregation. DCM and acetone were used to dissolve PMMA and disperse silica particles. FIG. 8 shows the particle size distribution of PMMA coated silica particles (180 nm). The operating conditions used for the coating experiments were 80 bar, 4 Watts, 35° C., 4 mL/min. The PMMA to silica ratio was 9.1 wt/wt % in (a); 16.7 wt/wt % in (b) and 23 wt/wt % in (c).

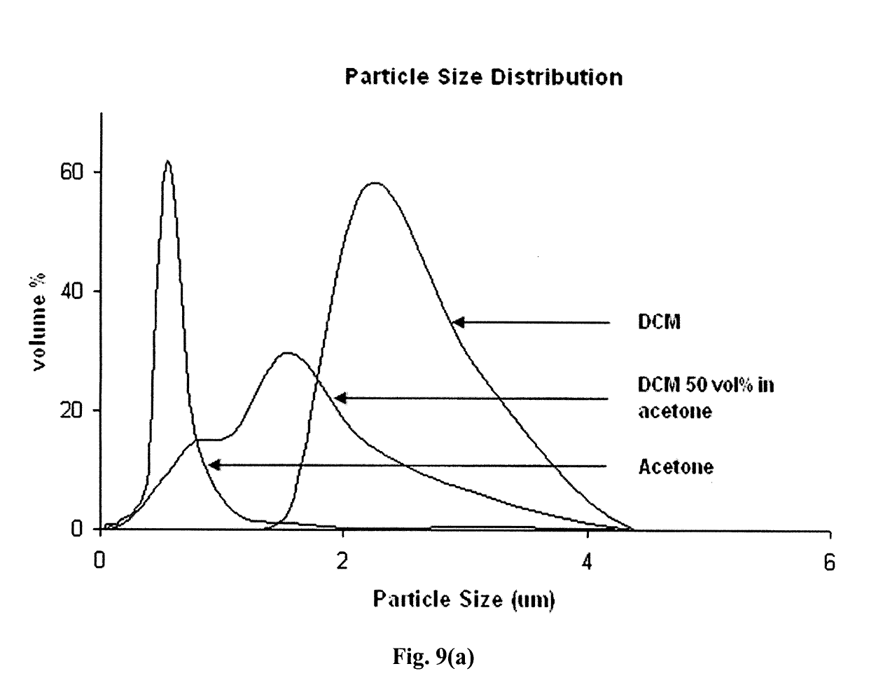

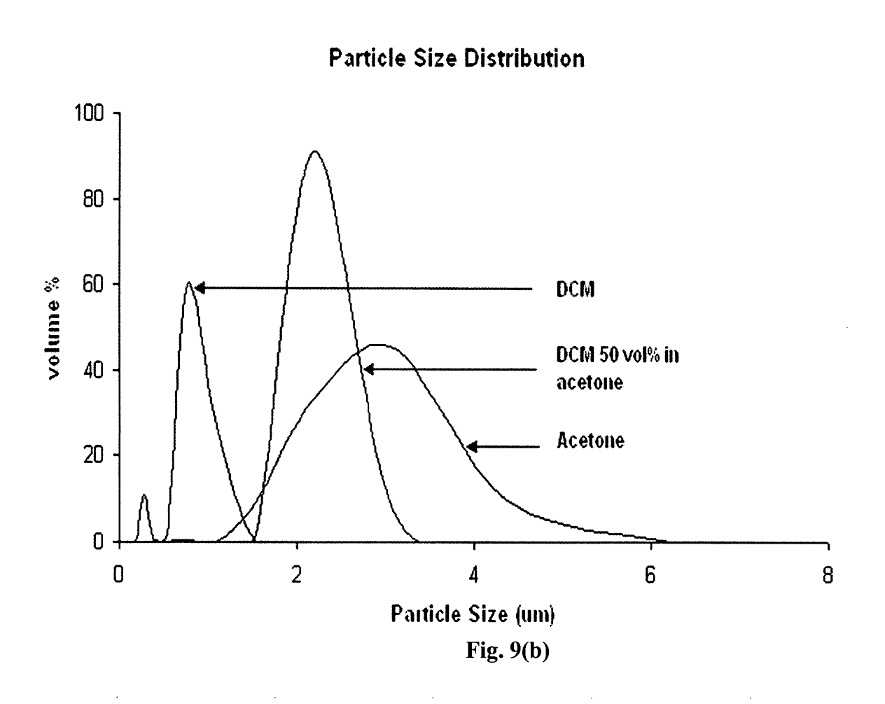

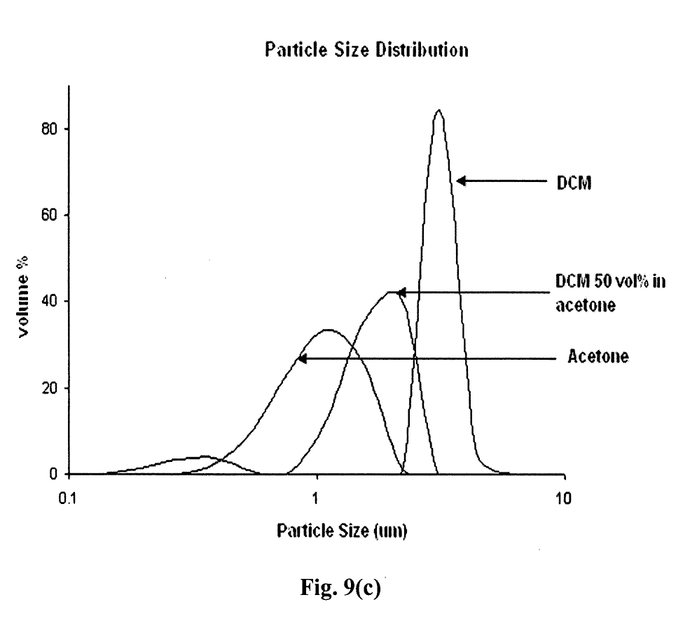

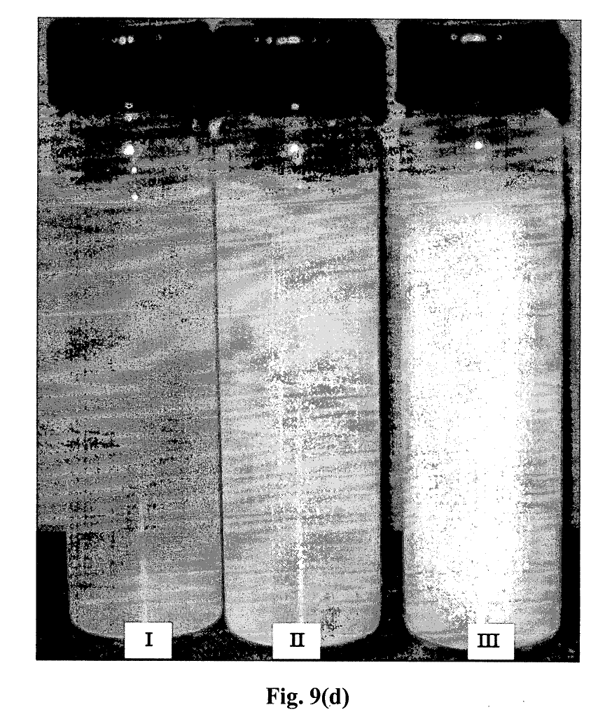

Silica particles disperse better in acetone than in DCM. FIG. 9 (d) shows the silica particles suspended in DCM, acetone and in a mixture of DCM and acetone. As can be seen from FIG. 9, silica particles disperse better in DCM than in acetone.

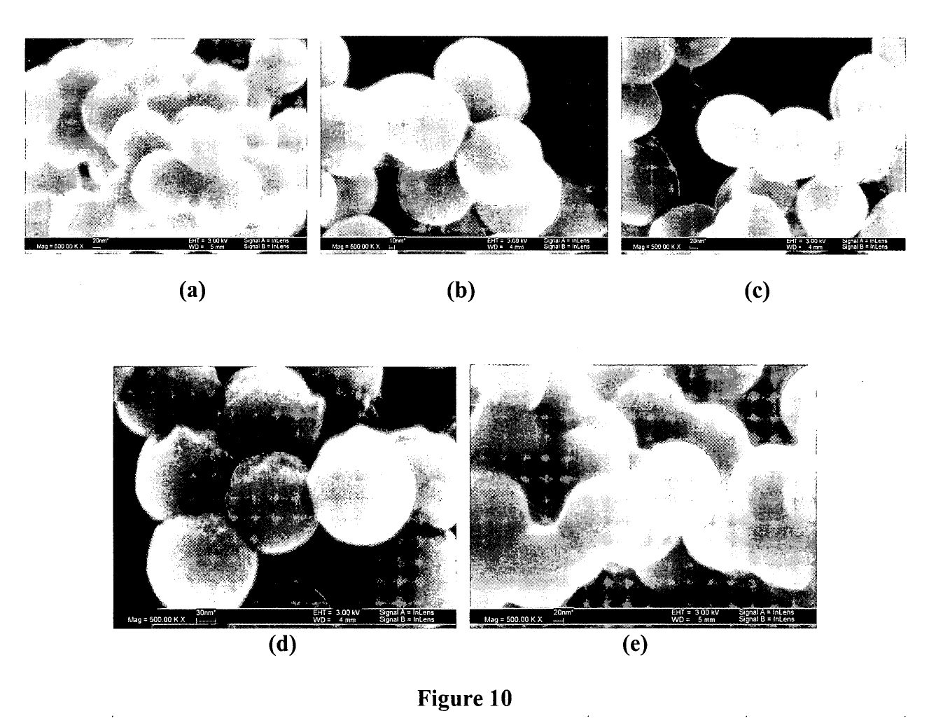

Hexane was used as a poor solvent for PMMA. Silica 180 nm sized particles were coated using PMMA dissolved in a mixture of DCM and hexane as well as acetone and hexane. Water works as a poor solvent for PMMA. However, hexane is soluble in supercritical CO₂ and the water is not soluble in supercritical CO₂ at 80 bar and 35° C. Hence, when water was used as poor solvent, PMMA coated silica particles with moisture were obtained. The moisture was then removed with vacuum drying. FIG. 10 shows the SEM images of the silica 180 nm sized particles coated with the PMMA: (a) DCM only; (b) hexane 30 vol/vol % in DCM; (c) acetone only; (d) hexane 30 vol/vol % in acetone and (e) water 30 vol/vol % in acetone.

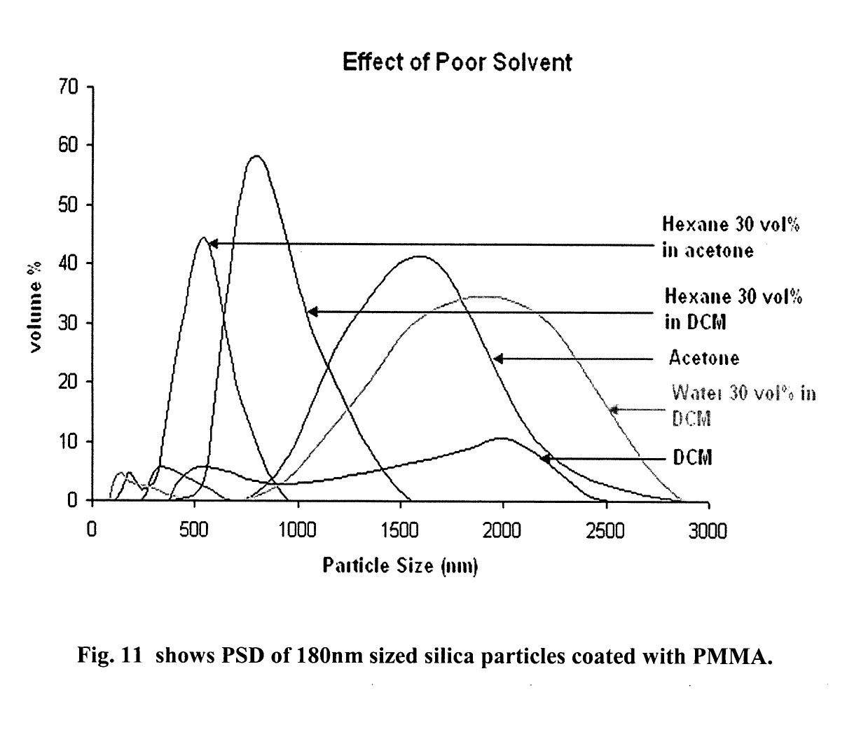

FIG. 11 shows the particle size distribution for silica 180 nm sized particles coated with PMMA. Solvents used included acetone, DCM, acetone-hexane, DCM-hexane and acetone-water to dissolve the PMMA polymer.

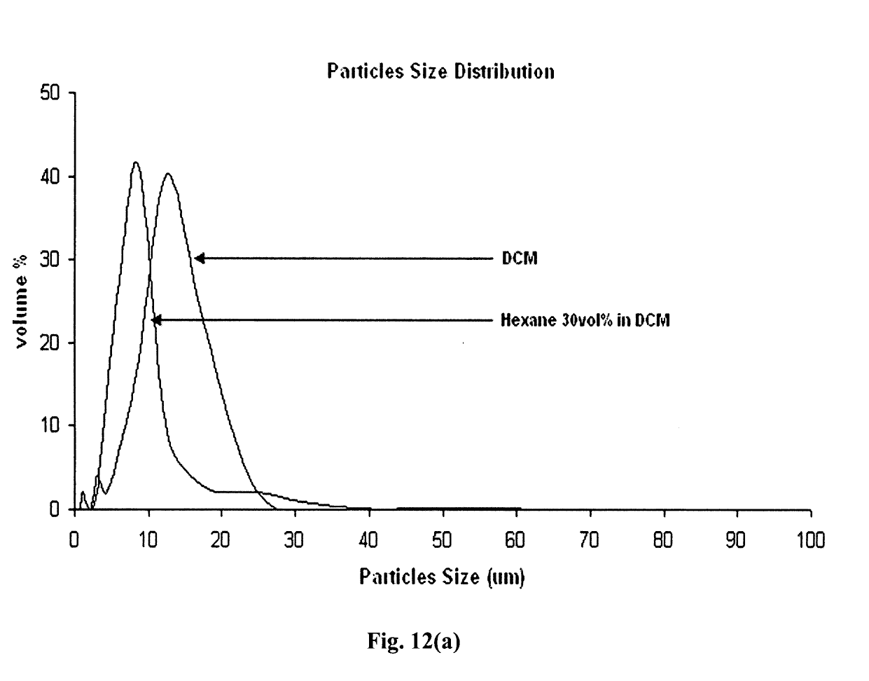

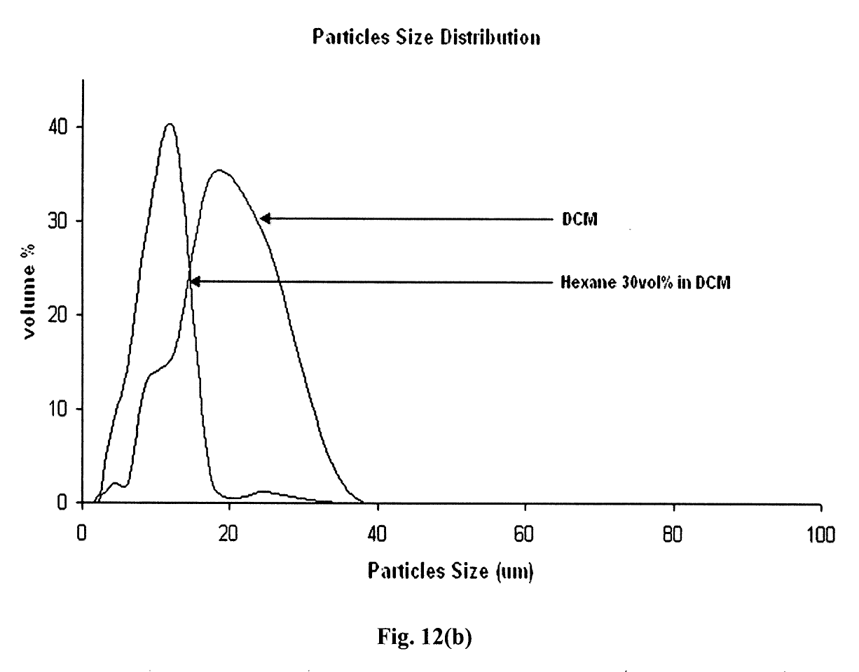

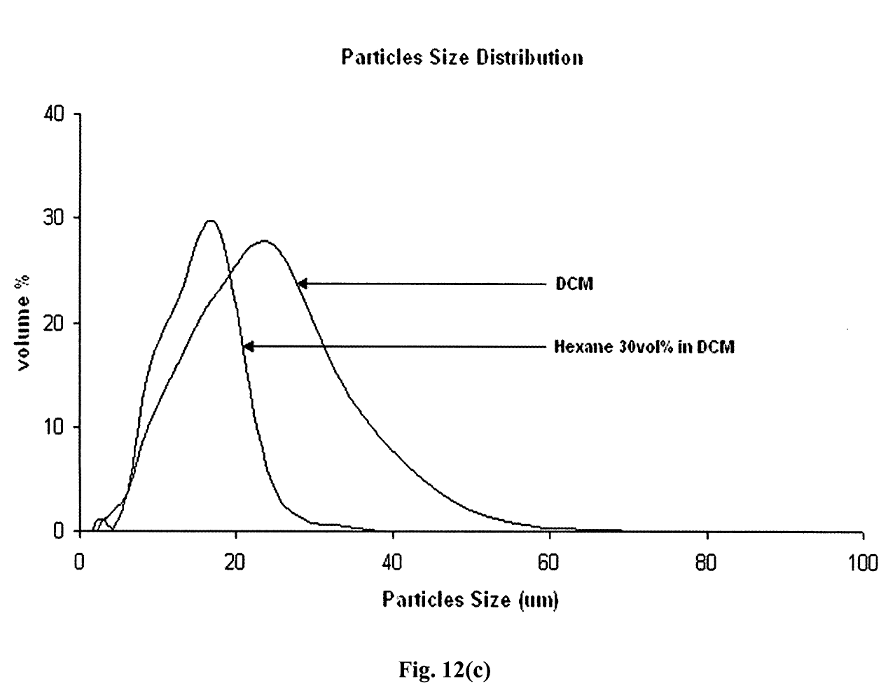

Effect of poor solvent on aggregate size was studied by using 2 μm sized silica as well. FIG. 12 shows the particle size distribution of PMMA coated silica particles with and without use of poor solvent: (a) PMMA is 9.1 wt/wt % with silica; (b) PMMA is 16.7 wt/wt % with silica and (c) PMMA is 23 wt/wt % with silica.

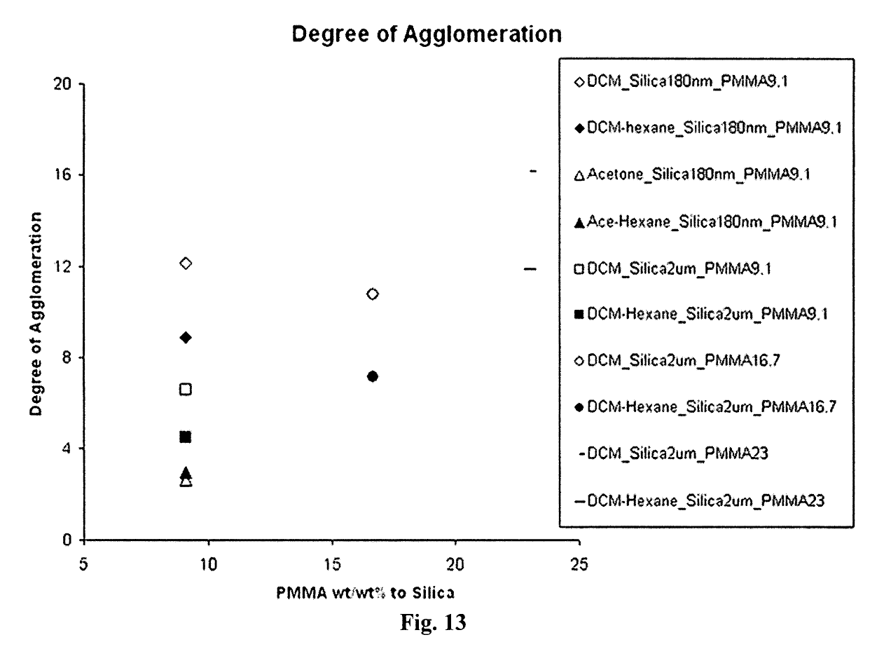

The degree of agglomeration increases with increase in polymer to silica ratio. However, agglomeration is reduced with an increase in silica particle size. Aggregation was reduced with the addition of poor solvent (hexane) but when water was used, the aggregation was increased. FIG. 13 shows the degree of agglomeration at various operating conditions. The operating pressure, ultrasonic nozzle power, temperature and solution flow rate were kept at 80 bar, 4 watts, 4 mL/min and 35° C., respectively.

Using a SAS method, deagglomerated particles with high coating efficiency can be formed. With increase in polymer ratio, agglomeration increases. The larger the host particle size, the lower the degree of agglomeration. Ultrasonic nozzle use helps in reduction in agglomeration and increase in production without affecting coating quality.

### EXAMPLE 3

A setup shown schematically in FIG. 14 is used for the visualization of the breakup patterns of liquids injected into supercritical CO₂. The visualization system includes a microscope zoom lens, a high-speed CCD camera, a computer with image capture software and a Nd:YAG dual cavity pulsed laser. To produce a larger amount of PVP particles for analysis, the view cell in this apparatus is replaced with a 910-mL high-pressure chamber placed inside a water bath. Fused silica capillaries of 10-μm, 20-μm, 40-μm, and 127-μm were used as micro-nozzles in experiments on the particle formation. The operational temperature is maintained at 35° C. while the operational pressure varies from 79 to 120 bar.

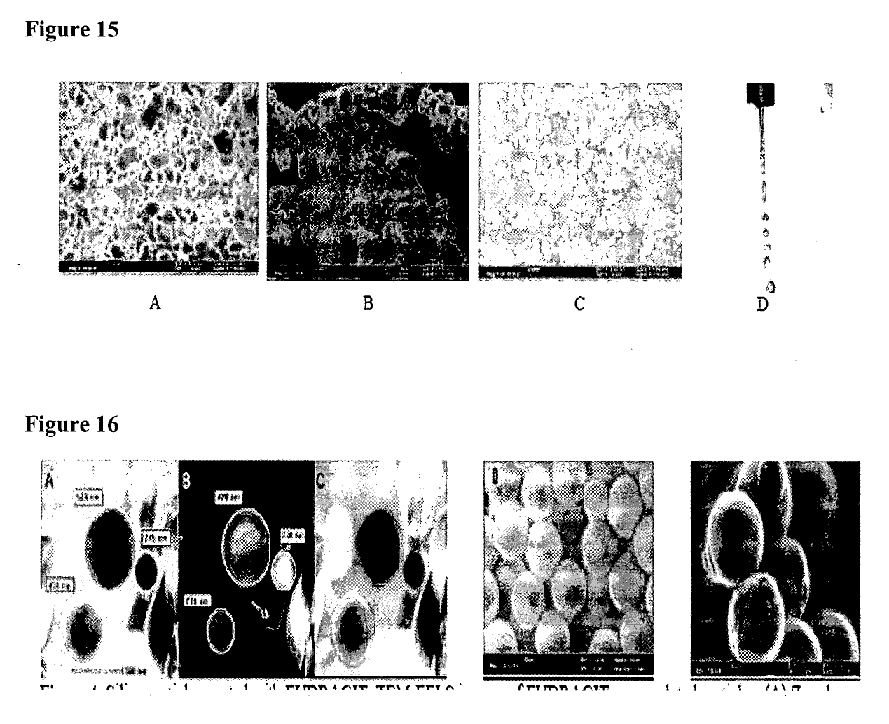

The breakup of liquids injected into supercritical CO₂ appears to be similar to that observed for the injection of a liquid into an immiscible liquid as shown in FIG. 15. For low flow rates, drops are formed individually at the tip of the nozzle and break off when they attain a particular size (dripping flow). In the jetting mode, which occurs at larger velocities, drops detach the jet tip at some distance downstream of the nozzle because of the growth of disturbances leading to the eventual jet breakup. The Rayleigh breakup, the first-wind-induced breakup, and the second-wind-induced breakup, were also clearly identifiable in the experiments. Increasing the acetone content in the solvent is found to suppress the particle aggregation, decrease the average particle size, and eliminate the surface irregularities of the PVP particles (FIG. 15). However, increasing the operational pressure well above the critical point is found to increase the average size of the PVP particles and broaden the particle size distribution. The use of the coaxial ultrasonic nozzle is found to facilitate coating of nanometer and sub-micrometer silica particles for the modification of their surface. Evenly coated silica particles and a thin layer of polymer coating can be easily observed from FIG. 16. The concept of “good” and “poor” solvents also results in a morphology variation of the obtained coated silica particles from the coaxial ultrasonic nozzle.

The variation of the acetone content of a solvent, the nozzle diameter, and the jet velocity is demonstrated to provide an efficient method to vary surface morphology of the PVP particles and their size from several tens of nanometers to several hundreds of nanometers. Operation at pressure slightly above the critical point is shown to favor the formation of a narrow particle size distribution. The ultra-fine silica particles are successfully coated with polymer by using a coaxial ultrasonic nozzle. The coaxial ultrasonic nozzle possesses potentials for future scale-up of SAS coating process.

Some alternative embodiments associated with the present disclosure include a variety of applications for the method described hereinabove. Exemplary applications include but are not limited to: a variety of uses in the pharmaceutical industry and nutraceutical industry, and food processing. It is also understood that a method according to the present disclosure can be used for ceramics, photography, explosives, dyes etc.

Methods associated with the present disclosure offer significant advantages over the prior art methods of production, formation and/or manufacture of particles. The advantageous properties and/or characteristics of the disclosed method include, but are not limited to, improved surface smoothness, reduction in particle size, decreased drying time, reduction in agglomeration, closer particle size distribution, ability to form encapsulated particles with improved film coating, versatility, environmentally friendly, cost effective and scalability for industry.

Methods according to the present disclosure have the distinct advantage of being able to smooth surface irregularities. Smoother surfaces in the target particle allows for increased effectiveness in many fields. For example, particle surface becomes a particularly important issue especially in drug delivery when a drug is attached/absorbed onto the surface. (See, e.g., Vinod Labhasetwar, Cuxian Song, William Humphrey, Ronald Shebuski, and Robert j. Levy, “Arterial Uptake of Biodegradable Nanoparticles: Effect of Surface Modifications,” Journal of Pharmaceutical Sciences, Vol. 87, No. 10, October 1998.) Surface smoothness facilitates in minimizing drug—carrier particle interactions resulting in more efficient drug detachment from the carrier particle surface which shows tremendous improvement in drug release efficiency. (See, e.g., Helena Schiavone, Srinivas Palakodaty, Andy Clark, Peter York, Stelios T. Tzannis, “Evaluation of SCF-engineered particle-based lactose blends in passive dry powder inhalers,” International Journal of pharmaceutics, 281 (2004) 55-66; Hassan Larhrib, Gary Peter Martin, Christopher Marriott, David Prime, “The influence of carrier and drug morphology on drug delivery from dry powder formulations,” International Journal of Pharmaceutics, 257 (2003) 283-296; Xian Ming Zeng, Gary P. Martin, Christopher Marriott, John Pritchard, “The influence of carrier morphology on drug delivery by dry powder inhalers,” International Journal of Pharmaceutics, 200 (2000) 93-106.)

Further advantages include the capability to decrease particle size. Reduction in particle size allows particles to be used in new applications or improve the quality of a product in which they are used. For example, many new drugs are poorly soluble in water, and having a smaller size particle improves bio-availability of these drugs and helps in reduced toxicity.

Methods according to the present disclosure are effective in reducing the time required for drying particles and provide much drier particles. This has significant advantages to the final process in terms of improved productivity and the product itself.

Further advantages associated with the present disclosure include reduced agglomeration of the target particles. Agglomerations limit the ability to use the target particles in many applications because although the agglomeration may be smaller than the initial solute, they are still larger than the newly precipitated primary target particles, thereby decreasing the effectiveness of the particle formation, production or manufacturing technique.

Exemplary methods according to the present disclosure are effective in enabling closer particle size distribution among newly produced target particles. More uniform particle size increases the effectiveness of the technique and differentiates it from the solutes generated by other SAS techniques. Uniform particle size also helps in the final utilization, for example in case of drug materials, uniform size leads to uniform bio-availability. Moreover, exemplary methods associated with the present disclosure may be effective in forming encapsulated particles with improved film coating.

A vast combination of solute(s), target particle(s), solvent(s), anti-solvent fluid(s), temperature, pressure, etc. can be effective in accomplishing a desired outcome using an exemplary method associated with the present disclosure so long as the operating conditions are adjusted such that the minimum requirements of interactions as illustrated in FIG. 1 are met. The ability to adjust this method illustrates its versatility so long as the base conditions are fulfilled.

Methods according to the present disclosure can be considered environmentally friendly in that the solvents and anti-solvent fluids can be reused and/or recycled. This prevents a decrease in waste products that can be detrimental to the environment. Moreover, exemplary methods associated with the present disclosure can be cost effective because the solvents and anti-solvent fluids can be reused thereby reducing the amount of overhead necessary to enable the exemplary methods described herein. An additional advantage associated with the present disclosure includes effective and efficient scalability to an industrial scale.

While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

We claim:

1. A method for forming particles comprising:
providing:
an anti-solvent fluid;
a first solvent that is soluble in the anti-solvent fluid;
a second solvent that soluble in the anti-solvent fluid and that is at least partially soluble or miscible with the first solvent;
a solute that is: (i) soluble in the first solvent; (ii) substantially insoluble in the second solvent; and (iii) substantially insoluble in the anti-solvent fluid;
contacting the first solvent, the second solvent and the solute together to form a solution; and
contacting the solution with the anti-solvent fluid to extract the first and the second solvents and precipitate the solute forming target particles.

2. A method according to claim 1, wherein the first solvent is a good solvent.

3. A method according to claim 1, wherein the second solvent is a poor solvent.

4. A method according to claim 1, wherein the contacting of the solution with the anti-solvent fluid occurs by injecting the solution through a capillary nozzle into the anti-solvent fluid.

5. A method according to claim 1, wherein the solute that precipitates out of the solution as a result of contact with the anti-solvent fluid is in particle form.

6. A method according to claim 1, wherein the target particle can be fine particles.

7. A method according to claim 6, wherein the fine particles are selected from the group consisting of: micron particles, submicron particles, nano-sized particles, and combinations thereof.

8. A method according claim 1, wherein the anti-solvent fluid is selected from the group consisting of: supercritical fluid, subcritical fluid, critical fluid, near critical fluid, and combinations thereof.

9. A method according to claim 1, wherein the solution further includes host particles suspended within the solution needing to be encapsulated or film coated.

10. A method according to claim 9, wherein the host particles are encapsulated or film-coated by the precipitation of the solute.
